(19) United States
(12) Patent Application Publication
(10) Pub. No.: US 2012/0099013 A1
(43) Pub. Date: Apr. 26, 2012

(54) APPARATUS AND METHOD FOR CREATING DOT LED IMAGE IN PORTABLE TERMINAL

(75) Inventors: Tae-Gi LEE, Gyeongsangbuk-do (KR); Mi-Kyung HAN, Gyeongsangbuk-do (KR)

(73) Assignee: SAMSUNG ELECTRONICS CO., LTD., Gyeonggi-Do (KR)

(21) Appl. No.: 13/277,725

(22) Filed: Oct. 20, 2011

(30) Foreign Application Priority Data
Oct. 20, 2010 (KR) 10-2010-0102473

(51) Int. Cl. H04N 5/225

(52) U.S. Cl. 348/333.01; 348/E05.024

(57) ABSTRACT

Provided is a method and apparatus for creating a dot LED image in a portable terminal. An apparatus for creating a dot LED image in a portable terminal includes a display unit and a control unit. The display unit displays a dot LED image that is automatically created. The control unit extracts an edge image from an image and automatically maps a dot LED to the extracted edge image to create the dot LED image.

### CLAIM OF PRIORITY

This application claims the benefit under 35 U.S.C. §119(a) of a Korean Patent Application filed in the Korean Intellectual Property Office on Oct. 20, 2010 and assigned Serial No. 10-2010-0102473, the entire disclosure of which is hereby incorporated by reference.

### BACKGROUND OF THE INVENTION

1. Field of the Invention

The present invention relates generally to an apparatus and method for creating a dot Light Emitting Diode (LED) image in a portable terminal, and more particularly, to an apparatus and method for conveniently creating various dot LED images in a portable terminal.

2. Description of the Related Art

Full touchscreen-type portable terminals and smart phones are recently in widespread use, but folder-type portable terminals are still popular with many users who prefers the folding/unfolding feature a folder-type portable terminal and an analog-type keypad.

Most of the conventional folder-type portable terminals have an internal Liquid Crystal Display (LCD) and an external LCD, but a recent folder-type portable terminal uses an LED lighting as an external display. The LED is used to display an image created by the user.

However, the user is inconvenienced by having to select dots from a dot frame one by one to create a desired dot LED image when creating an image by the LED lighting.

### SUMMARY OF THE INVENTION

An exemplary embodiment of the present invention is to provide an apparatus and method for creating a dot LED image in a portable terminal, which can conveniently create various dot LED images in a portable terminal.

According to an aspect of the present invention, an apparatus for creating a dot LED image in a portable terminal includes: a display unit for displaying a dot LED image that is automatically created; and a control unit for extracting an edge image from an image and automatically mapping a dot LED to the extracted edge image to create the dot LED image.

According to another aspect of the present invention, a method for creating a dot LED image in a portable terminal includes: extracting an edge image from an image; and creating a dot LED image by automatically mapping a dot LED to the extracted edge image.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 is a block diagram of a portable terminal according to an exemplary embodiment of the present invention; and

FIG. 2 is a flow diagram illustrating a process for creating a dot LED image in a portable terminal according to an exemplary embodiment of the present invention.

### DETAILED DESCRIPTION

Exemplary embodiments of the present invention will be described below in detail with reference to the accompanying drawings. Like reference numerals in the drawings denote like elements. The present invention may, however, be embodied in different forms and should not be construed as limited to the embodiments set forth herein; rather, these embodiments are provided so that this disclosure will be thorough and complete, and will fully convey the scope of the present invention to those skilled in the art.

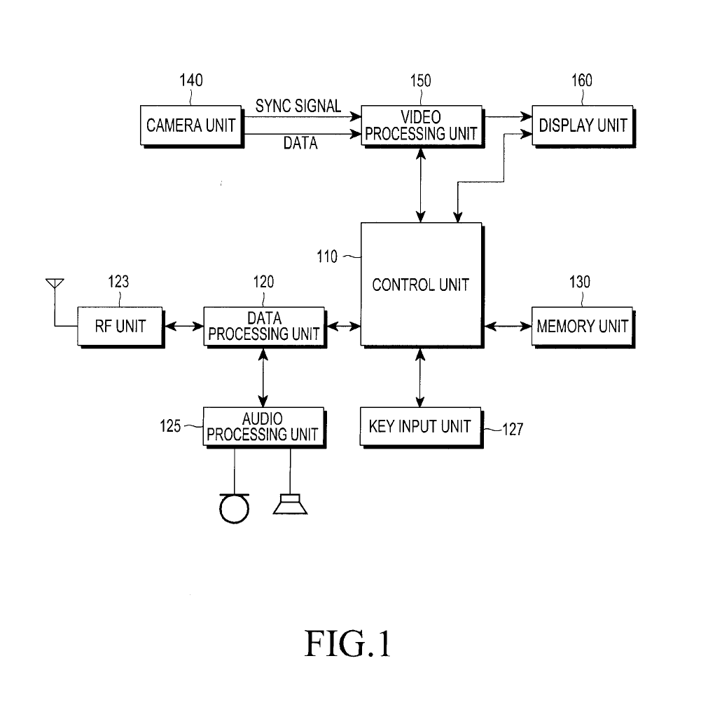

FIG. 1 is a block diagram of a portable terminal according to an exemplary embodiment of the present invention.

Referring now to FIG. 1, a portable terminal according to an exemplary embodiment of the present invention includes a control unit 110, a data processing unit 120, a radio frequency (RF) unit 123, an audio processing unit 125, a key input unit 127, a memory unit 130, a camera unit 140, a video processing unit 150, and a display unit 160.

In operation, the RF unit 123 performs a wireless communication function of the portable terminal. The RF unit 123 includes an RF transmitter for upconverting and amplifying a transmission (TX) signal, and an RF receiver for low-noise-amplifying and downconverting a received (RX) signal. The data processing unit 120 includes a transmitter for encoding and modulating the TX signal, and a receiver for demodulating and decoding the RX signal. For example, the data processing unit 120 includes a modem and a codec. Herein, the codec includes a data codec for processing packet data, and an audio codec for processing audio signals (e.g., voice signals). The audio processing unit 125 processes an RX audio signal outputted from the audio codec of the data processing unit 120, and transmits a TX audio signal, generated by a microphone, to the audio codec of the data processing unit 120.

The key input unit 127 includes keys for inputting numeral and character information, and function keys for setting various functions.

The memory unit 130 may include a program memory and a data memory. The program memory may store programs for controlling a general operation of the portable terminal, and programs for automatically creating an extracted edge image as a dot LED image.

According to an exemplary embodiment, the memory unit 130 stores various images such as a received or downloaded image and an image captured by the camera unit 140.

The control unit 110 controls an overall operation of the portable terminal.

According to an exemplary embodiment, the control unit 110 extracts an edge 30 image from an image and automatically maps a dot LED to the extracted edge image to create a dot LED image. Herein, the image may be an image captured by the camera unit 140 or an image selected by the user from images stored in the memory unit 130.

According to an exemplary embodiment, in order to automatically map the dot LED to the extracted edge image, the control unit 110 resizes the edge image to a size 35 corresponding to a dot frame and activates the dot LED about the dots of the dot frame corresponding to position of edges in the edge image.

According to an exemplary embodiment, when an edit mode for the created dot LED image is selected, the control unit 110 edits the created dot LED image.

According to an exemplary embodiment, when a storage mode for the created dot LED image is selected, the control unit 110 stores the created dot LED image.

The camera unit 140 includes a camera sensor for capturing video data and converting the video data into an electrical signal, and a signal processing unit for converting an analog video signal, captured by the camera sensor, into digital data. The camera sensor may include a CCD sensor or a CMOS sensor, and the signal processing unit may include a digital signal processor (DSP). Also, the camera sensor and the signal processing unit may be integrated into one unit, or may be separated from each other.

According to an exemplary embodiment, the camera unit 140 captures an image for creating a dot LED image. Herein, the image may be a picture drawn on paper by the user.

The video processing unit 150 performs an image signal processing (ISP) operation to display video signals, outputted from the camera unit 140, on the display unit 160. Examples of the ISP operation include gamma correction, interpolation, spatial change, image effects, image scaling, auto white balance (AWB), auto exposure (AE), and auto focus (AF). The video processing unit 150 processes the video signals, outputted from the camera unit 140, on a frame basis, and outputs the frame video data according to the size and characteristics of the display unit 160. Also, the video processing unit 150 includes a video codec to compress the frame video data displayed on the display unit 160 and restore the compressed frame video data into the original frame video data. The video codec may include a JPEG codec, an MPEG4 codec, or a Wavelet codec. The video processing unit 150 may have an on-screen display (OSD) function to output OSD data in accordance with a display screen size under the control of the control unit 110.

The display unit 160 displays the video signal outputted from the video processing unit 150, and displays the user data outputted from the control unit 110.

The display unit 160 may be implemented using an LCD. If the display unit 160 is implemented using an LCD, the display unit 160 may include an LCD panel, an LCD controller, and a memory for storing video data. The LCD may be a touchscreen LCD. If the LCD is a touchscreen LCD, it may also operate as an input unit. Also, the display unit 160 may display the keys of the key input unit 127.

According to an exemplary embodiment, the display unit 160 may display a dot LED image that is automatically created according to the present invention.

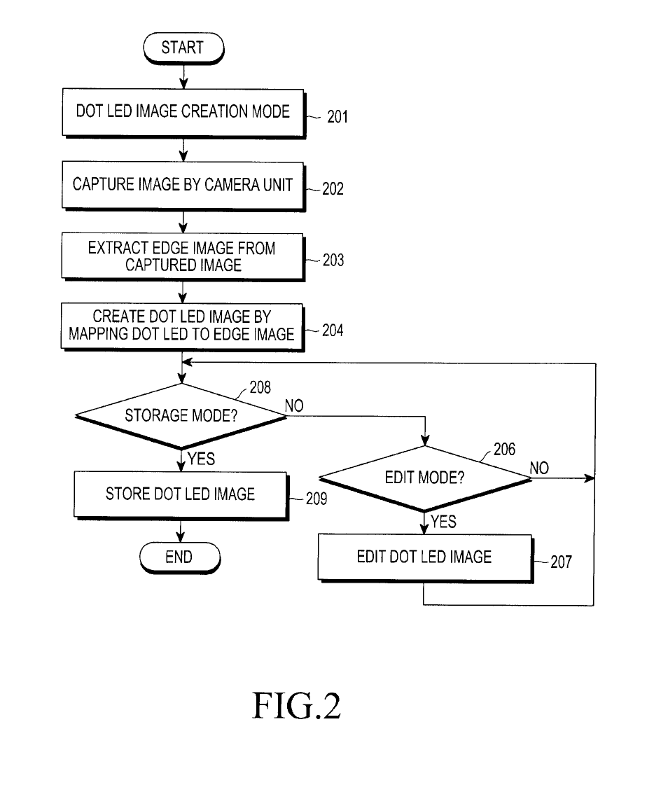

FIG. 2 is a flow diagram illustrating a process for creating a dot LED image in the portable terminal according to an exemplary embodiment of the present invention.

Referring to FIGS. 1 and 2, when a dot LED image creation mode is selected in the portable terminal, the control unit 110 converts the portable terminal to the dot LED image creation mode in step 201.

When a camera mode is selected in the dot LED image creation mode of step 201, the control unit 110 automatically drives the camera unit 140. When an image is captured by the camera unit 140 in step 202, the control unit 110 extracts an edge image from the captured image in step 203.

The image captured in step 202 may be a picture that is drawn on paper by the user to obtain a desired dot LED image.

Alternatively, when an image mode is selected in the dot LED image creation mode of step 201, the control unit 110 may display images stored in the memory unit 130 and extract an edge image from an image selected by the user from the displayed images.

The technique of extracting an edge image from the captured image is well known in the art and thus a description thereof is omitted for conciseness.

When an edge image is extracted in step 203, the control unit 110 resizes the edge image to a size corresponding to a dot frame (i.e. LED frame) in step 204.

The dot frame includes a plurality of dots aligned. In a manual dot LED image creation mode, dots for creation of a desired image are selected from the dots of the dot frame and the dot LED is activated about the selected dots to create a desired dot LED image. Stated another way, a process involves creating the dot LED image manually, apart from the process of creating the dot LED image, automatically. For example, to create a heart-shaped dot LED image, the user selects only the corresponding dots for creating the heart-shaped among a plurality of the dot frames, and the control unit creates the heart-shaped dot LED image by only utilizing the selected dots.

In step 204, the control unit 110 extracts the dots of the dot frame corresponding to position of edges in the resized edge image and activates the dot LED about the extracted dots to create a dot LED image. The resized edge image and the dot frame 35 have the same size. Therefore, the control unit creates the dot LED image corresponding to the edge image by only utilizing the dots having the position corresponding to the positions of the edges in the resized edge image among a plurality of the dots in the dot frame.

When the dot LED image created in step 204 is displayed on the display unit 160 and an edit mode thereof is selected by the user in step 206, the control unit 110 edits the displayed dot LED image under the control of the user in step 207.

On the other hand, when the dot LED image created in step 204 is displayed on the display unit 160 and a storage mode thereof is selected by the user in step 208, the control unit 110 stores the displayed dot LED image in step 209.

As described above, the present invention provides an apparatus and method for creating a dot LED image in a portable terminal, thereby making it possible to conveniently create various dot LED images in a portable terminal.

The above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be executed by such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein.

While the invention has been shown and described with reference to exemplary embodiments thereof, it will be understood by those skilled in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

What is claimed is:

1. An apparatus for creating a dot Light Emitting Diode (LED) image in a portable terminal, comprising:
a display unit for displaying a dot LED image that is automatically created; and
a control unit for extracting an edge image from an image and automatically mapping a dot LED to the extracted edge image to create the dot LED image.

2. The apparatus of claim 1, wherein the control unit resizes the edge image to a size corresponding to a dot frame and activated a dot LED about dots of the dot frame corresponding to position of edges in the edge image to automatically map the dot LED to the edge image.

3. The apparatus of claim 1, wherein when an edit mode for the created dot LED image is selected, the control unit edits the created dot LED image.

4. The apparatus of claim 1, wherein when a storage mode for the created dot LED image is selected, the control unit stores the created dot LED image.

5. The apparatus of claim 1, further comprising:
a camera unit for capturing the image; and
a memory unit for storing the image.

6. A method for creating a dot Light Emitting Diode (LED) image in a portable terminal, comprising:
extracting an edge image from an image; and
creating a dot LED image by automatically mapping a dot LED to the extracted edge image.

7. The method of claim 6, wherein the creating of the dot LED image comprises:
resizing the edge image to a size corresponding to a dot frame;
extracting dots of the dot frame corresponding to position of edges in the edge image; and
automatically activating a dot LED about the extracted dots.

8. The method of claim 6, further comprising:
editing the created dot LED image when an edit mode for the created dot LED image is selected.

9. The method of claim 6, further comprising:
storing the created dot LED image when a storage mode for the created dot LED image is selected.

10. The method of claim 6, wherein the image is captured by a camera unit or is extracted from a memory unit.
